(19) United States
(12) Patent Application Publication
(10) Pub. No.: US 2003/0112461 A1
(43) Pub. Date: Jun. 19, 2003

(54) Image forming system

(75) Inventor: Kaori Ogura, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/020,158

(22) Filed: Dec. 18, 2001

(51) Int. Cl. B41J 1/00; G06F 15/00

(52) U.S. Cl. 358/1.15; 358/402

(57) ABSTRACT

Electronic mail is sent from an external device to an image forming apparatus to call for updating of the data stored in a memory of the image forming apparatus. Upon reception of the image forming apparatus, the image forming apparatus downloads updating data from a device on a network on the basis of the contents of the electronic mail. Based on the downloaded updating data, the image forming apparatus executes updating processing for the data stored in the memory.

### BACKGROUND OF THE INVENTION

The present invention relates to an image forming system comprising an image forming apparatus, an example of which is a digital copying machine having a variety of functions. The functions include a scanner function, a printer function, a copying machine function, a facsimile machine function, a network communication function, etc.

In a conventional image forming apparatus such as a digital copying machine, a variety of functions are attained based on software stored in a memory of the digital copying machine. There may be a case where the software must be upgraded to renew the control programs or control data.

To update the software, the conventional digital copying machine is connected to a telephone line, and updating data is downloaded by facsimile communication. The telephone line is not necessarily needed for the updating operation, and a serviceperson may go to the site of the digital copying machine and update the software, using jigs and utilizing local connection.

However, downloading the updating data by utilization of facsimile communication has the following problems. First, the downloading takes time due to the limited data transfer rate using facsimile transmission. Since the usage time of the telephone line is long, the communication expenses including the usage charge of the telephone line are high, accordingly. In addition, if the facsimile communication fails during the downloading operation, the downloading operation has to be started from the beginning. Further, the operator whose provides the service must wait for the updating operation to end.

The on-the-spot updating operation which does not use the telephone line has the following problems. First, the service provider that takes care of the updating operation must send personnel (servicepersons). This means that a traveling expense or a sending expense is required. In addition, the travel time to the spot inevitably delays the completion of the updating operation. If a trouble that cannot be solved on the spot occurs, the completion of the updating operation is delayed, accordingly.

### BRIEF SUMMARY OF THE INVENTION

As described above, much time or an extra cost is required for updating the software stored in the image forming apparatus beforehand. Accordingly, the present invention is intended to provide a data updating method for an image forming apparatus, an image forming apparatus, and an image forming system, which do not require long time or extra cost and yet enable an efficient updating operation of software that is stored in the image forming apparatus beforehand.

The data updating method for an image forming apparatus, which is provided in accordance with the present invention, is a method for updating the data stored in a memory of the image forming apparatus and comprises: sending electronic mail from an external device to the image forming apparatus to call for updating of the data stored in the memory of the image forming apparatus; downloading updating data from a device on a network on the basis of contents of the electronic mail when the electronic mail from the external device has been received by the image forming apparatus; and executing updating processing for the data stored in the memory on the basis of the downloaded updating data.

The image forming apparatus provided in accordance with the present invention stores data in its memory beforehand and comprises: a network interface which receives from an external device electronic mail calling for updating of the data stored in the memory and through which updating data is downloaded from a device on a network on the basis of contents of the electronic mail in response to the reception of the electronic mail; and a CPU which executes updating processing for the data stored in the memory on the basis of the updating data downloaded through the network interface.

The image forming system provided in accordance with the present invention comprises: an image forming apparatus which stores data in its memory beforehand; and an external device capable of exchanging electronic mail with the image forming apparatus. The external device includes a modem which sends electronic mail to the image forming apparatus to call for updating of the data stored in the memory of the image forming apparatus. The image forming apparatus includes: a network interface through which updating data is downloaded from a device on a network on the basis of contents of the electronic mail in response to the reception of that electronic mail; and a CPU which executes updating processing for the data stored in the memory on the basis of the updating data downloaded through the network interface.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiments of the invention, and together with the general description given above and the detailed description of the embodiments given below, serve to explain the principles of the invention.

FIG. 1 is a diagram showing a schematic structure of a network system which is according to the image forming system of the present invention.

FIG. 2 is a block diagram showing the structure of the control system of the digital copying machine depicted in FIG. 1.

FIG. 3 is a flowchart illustrating the operations the PC performs when the software of the digital copying machine is updated.

FIG. 4 is an example of mail sent from the PC to the digital copying machine.

FIG. 5 is an example of mail sent from the digital copying machine to the PC.

FIG. 6 is a flowchart illustrating the updating processing of the digital copying machine.

### DETAILED DESCRIPTION OF THE INVENTION

An embodiment of the present invention will now be described with reference to the accompanying drawings.

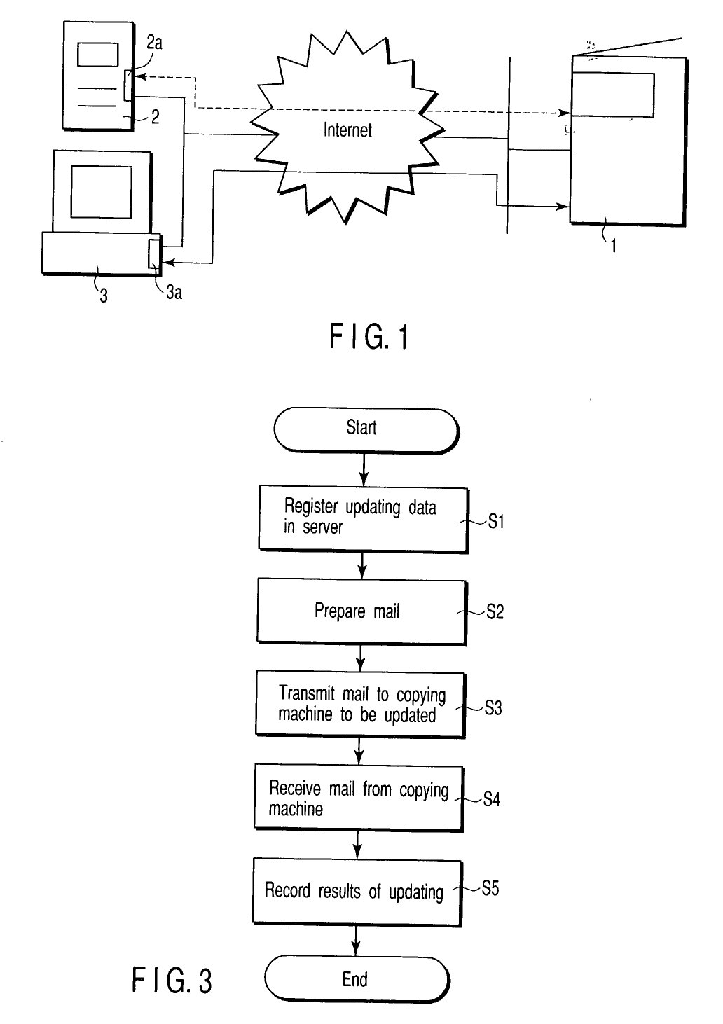

FIG. 1 is a diagram showing a schematic structure of a network system which is according to the image forming system of the present invention.

As shown in FIG. 1, the network system comprises a digital copying machine 1, a server 2, a personal computer (PC) 3, etc. The digital copying machine 1, the server 2 and the PC 3 are connected together through a network, such as the Internet. In addition, the server 2 and the PC 3 are connected to each other through a local area network (LAN).

The digital copying machine 1 has a variety of functions, including a copying machine function, a scanner function, a printer function, a facsimile machine function, a network communication function, etc. The digital copying machine 1 offers these functions to general users. The digital copying machine 1 has a network communication function; it can be connected to the Internet. The network communication function enables the digital copying machine 1 to exchange mail with the PC 3 or download data from the server 2 on the Internet.

The server 2 is managed by the service provider. The server 2 is, for example, a personal computer (PC) and includes a controller (e.g., a CPU), a storage section which stores data, a network interface 2a which performs communication with the network, etc. The storage section stores updating data for updating the digital copying machine 1, etc. The network interface 2a is an interface used for connection to the LAN or Internet and enables communication with a device on the network.

The PC 3, as well as the server 2, is used by the service provider. Like an ordinary personal computer, the PC 3 comprises a controller (e.g., a CPU), an operation section (e.g., a keyboard), a display section (e.g., a CRT or an LCD), a storage section (e.g., an HDD), a network interface (modem) 3a, etc. The network interface 3a is connected to the LAN or Internet and performs communication with a device on the network. The PC 3 has a function of registering updating data in the server 2 through the network interface 3a. The PC also has a function of exchanging mail with a device on the network through the network interface.

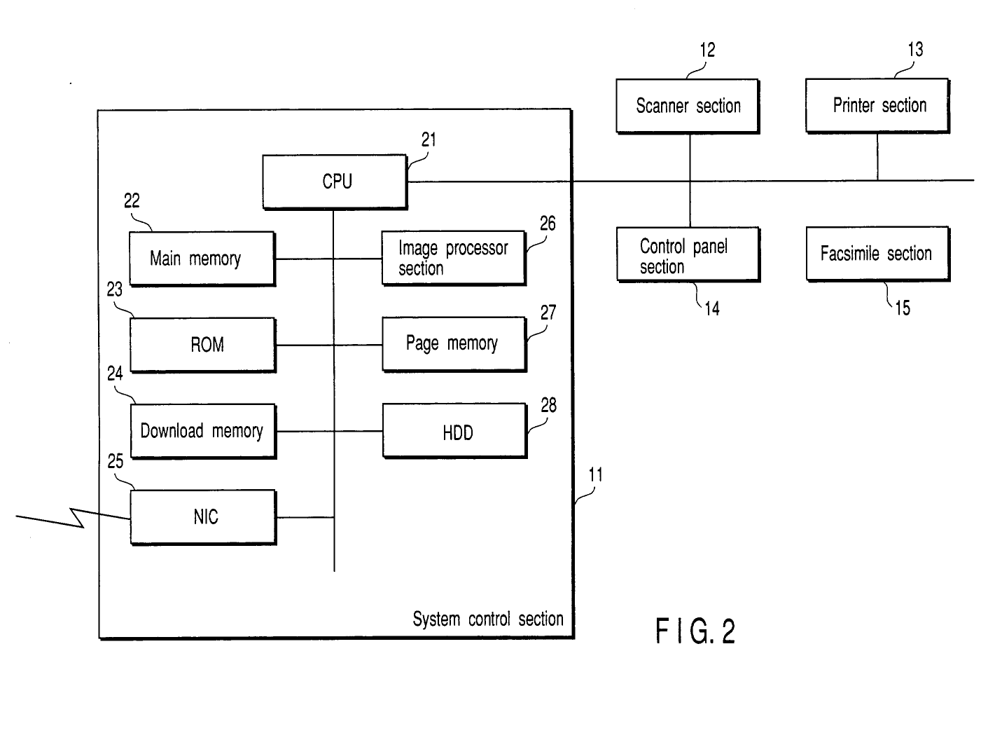

FIG. 2 is a block diagram showing the control system of the digital copying machine 1.

The digital copying machine 1 comprises a system controller 11, a scanner 12, a printer 13, a control panel 14, a facsimile section 15, etc. The system controller 11 controls the entire digital copying machine. The scanner 12 optically reads a document image. The printer 13 prints an image on an image formation medium. The control panel 14 functions as a user interface and is, for example, a liquid crystal display provided with a built-in touch panel. The facsimile section 15 performs transmission or reception of facsimile data.

As shown in FIG. 2, the system controller 11 comprises a CPU 21, a main memory 22, a ROM 23, a download memory 24, a network interface card (NIC) 25, an image processor 26, a page memory 27 and a hard disk drive (HDD) 28.

The CPU 21 controls the entire system controller 11. The CPU 21 runs a program prepared in a predetermined format. The main memory 22 is a RAM, for example, and temporarily stores work data.

The ROM 23 is a nonvolatile memory, such as an electrically rewritable flash ROM. The ROM 23 stores data (software) that need not be rewritten at ordinary times, including a control program and various kinds of data. The control program and data are stored in the ROM 23, with version information being attached.

The NIC 25 is connected to the Internet through the LAN or directly. The NIC 25 has a function of receiving and transmitting mail through the Internet, and a function of downloading data from the server 2. A download protocol is predetermined for the NIC so as to download data from the server 2.

The image processor 26 executes image processing. The image processor may be provided with a flash ROM which stores a control program, such as an image processing protocol. The page memory 27 is a memory designed to store image data page by page. The HDD 28 stores a large amount of data, such as compressed image data. Alternatively, the HDD 28 may store a control program and various kinds of data (software).

A description will now be given as to how the software stored in the digital copying machine 1 is updated.

FIG. 3 is a flowchart illustrating the operations the PC 3 performs when the software stored in the digital copying machine 1 is updated. In the descriptions below, reference will be made to the case where the control program stored in the ROM 23 is updated. The data stored in memories other than the ROM 23, such as the HDD, can be updated in a similar manner.

When the control program stored in the ROM 23 of the digital copying machine 1 must be updated, the service provider prepares a control program for updating (namely, updating data). The updating data is registered in the server 2 when an operator of the service provider operates the PC 3 (Step S1). The updating data includes version information as well as the control program for updating.

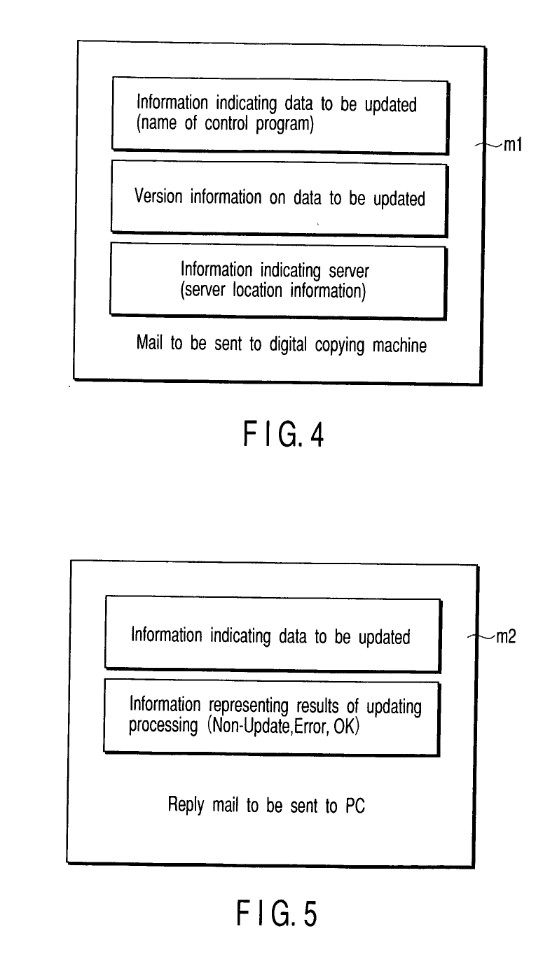

When the updating data is registered in the server 2, the operator of the service provider operates the PC 3 to prepare mail m1 to be sent to the digital copying machine 1 (Step S2). FIG. 4 shows an example of the mail m1 to be sent to the digital copying machine 1. As shown in FIG. 4, the mail m1 to the digital copying machine 1 contains information indicating data (control program) to be updated, version information on the data (control program) to be updated, information (location information) indicating which server 2 stores the updating data, etc. The mail m1, which is to be sent to the digital copying machine 1 to call for the updating of software, contains a predetermined command and a parameter that are described in a format the digital copying machine 1 can recognize, such as XML format.

After the mail m1 to be sent to the digital copying machine 1 is prepared in the above manner, the operator of the service provider operates the PC 3. By this operation, the mail m1 is transmitted to the digital copying machine 1 to be updated (Step S3). At the time of transmission, the mail m1 may be addressed to a particular digital copying machine 1 or to all digital copying machines that are managed by the service provider. The mail m1 may be sent to a plurality of digital copying machines on the basis of a certain condition. For example, it may be sent to the machines of the same model number.

After sending the mail m1 as above, the PC 3 waits for reply mail m2 to come. The reply mail m2 is sent by the digital copying machine 1 which mail m1 is sent to and which indicates the results of updating processing. FIG. 5 shows an example of the reply mail m2 sent from the digital copying machine 1 to the PC 3. As shown in FIG. 5, the reply mail m2 sent from the digital copying machine 1 to the PC 3 contains information indicating data (control program) to be updated, information representing the results of the updating processing, etc.

Upon receipt of the reply mail m2 from the digital copying machine 1 (Step S4), the PC 3 saves the reply mail m2 or its contents in a storage section (not shown). As a result, the PC 3 can manage the results of updating. In response to the reception of the reply mail m2, the PC 3 may display the results of updating on a display section (not shown) on the basis of the contents of the reply mail m2.

A description will now be given of the updating processing executed for the software of the digital copying machine 1.

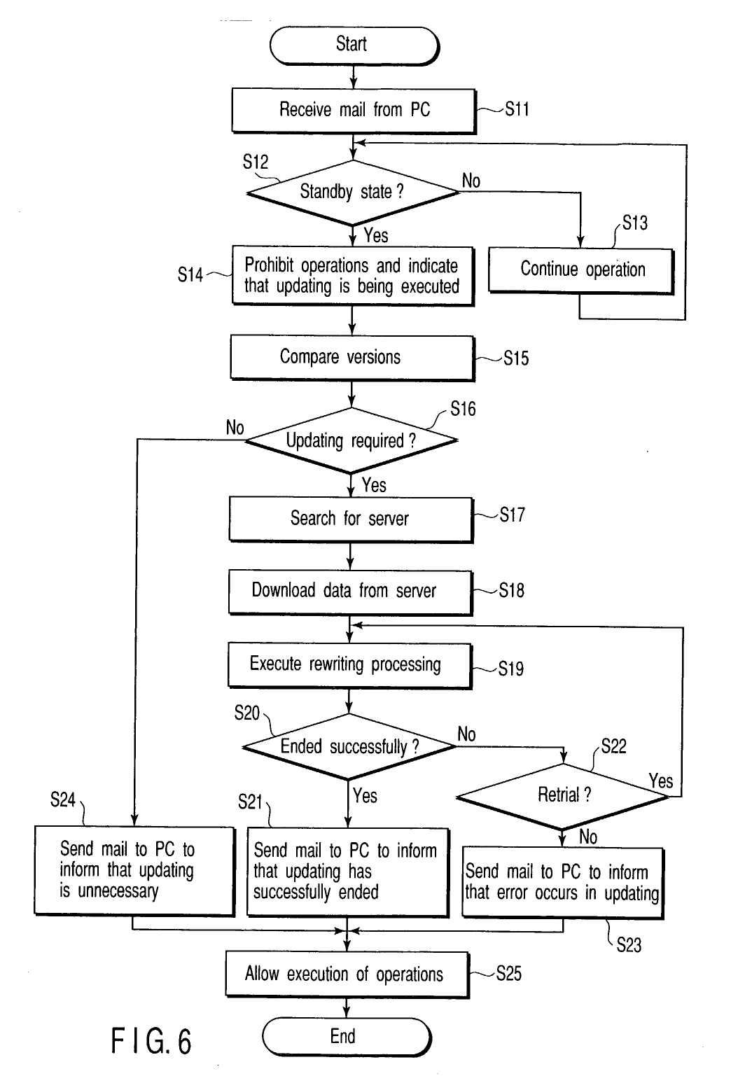

FIG. 6 is a flowchart illustrating the updating processing of the digital copying machine 1 that receives mail m1 from the PC 3.

First of all, mail m1, sent from the PC 3 and calling for updating, is transmitted over the Internet and received by the NIC 25 of the digital copying machine 1 (Step S11). After receiving the mail m1 sent from the PC 3 and calling for updating, the CPU 21 of the digital copying machine 1 saves it in the main memory 22.

After the received mail m1 is saved in the main memory 22, the CPU 21 determines whether the digital copying machine 1 is in the standby state (Step S12). When this determination shows that the digital copying machine 1 is not in the standby state (is operating) (“NO” in Step S12), the CPU 21 continues the processing, with the mail m1 being held in the main memory 22 (Step S13). In other words, if the CPU 21 is executing a scan operation, a print operation, facsimile communication or receiving inputs entered from the control panel when the mail m1 is received, the CPU 21 completes the ongoing operation and does not execute the updating operation based on the mail m1 until the digital copying machine 1 comes into the standby state. Owing to this, the updating processing based on the mail can be executed in a stable manner, without the ongoing operation being interrupted.

When the determination described above shows that the copying machine 1 is in the standby state (“YES” in Step S12), the CPU 21 prohibits operations other than the updating processing (Step S14) to prepare for the updating processing based on the contents of the mail m1. At the moment, the CPU 21 causes the control panel to display a message indicating to the user that updating processing is being executed. In this manner, the updating processing can be performed in a stable manner, without being interrupted for another kind of processing.

In the standby state of the digital copying machine 1, the CPU 21 reads out the version information on the control program to be updated from the mail m1. Then, the CPU 21 compares the version information read out from the mail m1 with the version information on the control program presently stored in the ROM 23 (Step S15). Based on this comparison, the CPU 21 determines whether or not the control program presently stored in the ROM 23 must be updated (Step S16). In this manner, the CPU 21 determines whether or not the control program must be updated by comparing the version information contained in the mail m1 with the version of the control program presently stored in the ROM 23.

When this determination shows that the updating is required (“YES” in Step S16), the CPU 21 checks the contents of the mail m1 and reads out information (server location information) indicating the server in which the updating data is registered. In this manner, the CPU 21 searches for the server 2 on the network on the basis of the server location information (Step S17). When the server 2 on the network is found as a result of this search operation, the CPU 21 downloads the updating data from the server 2 through the NIC 25. When downloading the updating data from the server 2, the CPU 21 conforms to the download protocol determined for the NIC 25 (Step S18). The data downloaded from the server 2 is stored in the download memory 24. After all updating data has been stored in the download memory 24, the CPU 21 terminates the downloading operation and disconnects itself from the server 2.

After completing the downloading operation of data from the server 2, the CPU 21 updates the control program stored in the ROM 23 (rewriting processing, updating processing) (Step S19). This control program updating processing is a self-updating process. That is, the control program updating processing is executed by rewriting the control program of the ROM 23 with the updating data stored in the download memory 24.

After the control program updating processing successfully comes to an end (“YES” in Step S20), the CPU 21 prepares reply mail m2 addressed to the PC 3 and indicating that the updating operation has successfully terminated. After preparing the reply mail m2 indicating the successful termination, the CPU 21 transmits that reply mail m2 from the NIC 25 over the Internet (Step S21).

If an error occurs in the process of rewriting the control program, the CPU 21 re-tries the rewriting operation. If this retrial operation is repeated without limit, it may continue forever. For this reason, the number of retrial operations executed is determined beforehand.

More specifically, if an error occurs in the process of rewriting the control program, the CPU 21 first determines whether or not the number of retrial operations has reached the predetermined number (Step S22). The number of retrial operations is counted up each time the rewriting operation is re-tried, and data on the counted number is stored in the main memory 22.

If the determination described above shows that the number of retrial operations has not reached the predetermined number (“YES” in Step S22), the CPU 21 returns to Step 19 and executes the control program updating processing once again.

On the other hand, if the determination described above shows that the number of retrial operations has reached the predetermined number (“NO” in Step S22), the CPU 21 determines that the control program updating operation (updating processing) has resulted in an error. Where an error in the updating processing is determined, the CPU 21 prepares reply mail m2 addressed to the PC 3 and indicating that the updating operation has resulted an error. After preparing the reply mail m2 indicating the error, the CPU 21 transmits that reply mail m2 from the NIC 25 over the Internet (Step S23).

If, in step S16, it is determined that the updating operation is unnecessary (“NO” in step S16), the CPU 21 prepares reply mail m2 which is addressed to the PC2 and which indicates that the updating is unnecessary. After preparing the reply mail m2 indicating that the updating is unnecessary, the CPU transmits it from the NIC 25 over the Internet (Step S24).

In the manner described above, the reply mail, which enables the PC 3 of the service provider to confirm the results of the updating processing, is sent from the copying machine to the PC 3. By virtue of this feature, the service provider requesting the updating operation can know whether the updating operation has been performed successfully or resulted in failure, or if the updating operation itself was unnecessary.

In steps S21, S23 and S24, the reply mail m2 representing the results of updating is sent to the PC 3. In response to this, the CPU 21 allows execution of the operations other than the updating operation (Step S25), which have been prohibited until then. As a result, the updating operation has been completed.

If the control program updating processing ends in failure in steps S19-S22, the control program that remains unupdated is available. Therefore, if the updating processing ends in failure, the digital copying machine 1 operates in the same condition as it was before the reception of the updating request.

If the failure in the rewriting processing is accompanied by the erasure of the control program of the last version (i.e., the version before the updating processing) or by the inoperative condition, the CPU 21 temporarily saves the unupdated data in the main memory 22 before the execution of the rewriting processing. Therefore, even if the rewriting processing ends in failure, and the control program of the last version is inexecutable, the CPU 21 reads out an executable control program of the last version from the main memory 22. Hence, despite the failure in the updating processing, the digital copying machine 1 is allowed to operate in the same state as it was before the reception of the updating processing.

As described above, mail that instructs the updating of software stored in the copying machine beforehand is sent from an external device to the copying machine by way of a network. The copying machine that receives this mail determines whether or not the updating is necessary. When the copying machine determines that the updating is necessary, the data required for the updating operation is downloaded from a device on the network in accordance with the contents of the mail, and the software of the copying machine is updated on the basis of the downloaded data.

Accordingly, the external device does not have to transmit the updating data to the copying machine though the updating data is usually attached to the mail as an attachment file. What is required of the external device is merely to transmit mail to the effect that the updating operation is necessary. Therefore, unnecessary transmission of data is not performed, both the time and cost of the updating operation can be reduced, and an efficient updating operation of the software is enabled. In addition, the time the digital copying machine must spare for the updating operation can be as short as possible.

It should be also noted that the digital copying machine automatically continues and completes the updating operation on the basis of the instructions given in electronic mail. It follows from this that an operator of the service provider does not have to monitor the operation or wait for the operation to end. Moreover, since the updating operation can be executed based on remote control, an operator does not have to go to the site of the copying machine so as to perform the updating operation. Hence, the personnel and cost for the updating operation can be reduced.

In comparison with the case where updating data is attached to electronic mail as an attachment file, it is advantageous to transfer that data from a download server on the basis of a download protocol, since this method has nothing to do with the problem wherein the electronic mail accompanied with an updating data file does not pass through a router.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data updating method for updating data stored in a memory of an image forming apparatus, comprising:
sending electronic mail from an external device to the image forming apparatus to call for updating of the data stored in the memory of the image forming apparatus;
downloading updating data from a device on a network based on contents of the electronic mail when the electronic mail from the external device has been received by the image forming apparatus; and
executing updating processing for the data stored in the memory, based on the downloaded updating data.

2. The data updating method for the image forming apparatus according to claim 1, wherein the electronic mail sent from the external device includes information indicating data to be updated, and information indicating which device on the network holds the updating data.

3. The data updating method for the image forming apparatus according to claim 1, wherein said executing updating processing includes: writing the updating data once again if the writing of the updating data in the memory fails and a number of times of failure is within a predetermined number; and determining that an error occurs in data updating processing if the number of times of failure reaches said predetermined number.

4. The data updating method for the image forming apparatus according to claim 1, further comprising:
causing the image forming apparatus to notify the external device of a result of the data updating processing.

5. The data updating method for the image forming apparatus according to claim 1, further comprising:
determining whether or not data updating is necessary based on the contents of the electronic mail when the image forming apparatus has received the electronic mail from the external device, and
wherein the updating data is downloaded from the device on the network based on the contents of the electronic mail when the data updating is determined to be necessary.

6. The data updating method for the image forming apparatus according to claim 5, wherein
the electronic mail sent from the external device includes version information on data to be updated; and
said determining whether or not the data updating is necessary includes comparing the version information included in the electronic mail with version information on the data stored in the memory, and determining whether or not updating is required with respect to the data stored in the memory.

7. The data updating method for the image forming apparatus according to claim 5, further comprising:
causing the image forming apparatus to notify the external device that data updating based on the electronic mail is unnecessary, when the data updating is determined to be unnecessary.

8. An image forming apparatus which stores data in a memory beforehand and comprises:
a network interface which receives from an external device electronic mail calling for updating of the data stored in the memory and through which updating data is downloaded from a device on a network based on contents of the electronic mail in response to the reception of the electronic mail; and
a CPU which executes updating processing for the data stored in the memory based on the updating data downloaded by the network interface.

9. The image forming apparatus according to claim 8, wherein the electronic mail sent from the external device includes information indicating data to be updated, and information indicating which device on the network holds the updating data.

10. The image forming apparatus according to claim 8, wherein said CPU writes the updating data once again if the writing of the updating data in the memory fails and a number of times of failure is within a predetermined number, and determines that an error occurs in data updating processing if the number of times of failure reaches said predetermined number.

11. The image forming apparatus according to claim 8, wherein said CPU causes the network interface to notify the external device of a result of the data updating processing.

12. The image forming apparatus according to claim 8, wherein said CPU determines whether or not data updating is necessary based on the contents of the electronic mail when the image forming apparatus has received the electronic mail from the external device, and
said network interface enables the updating data to be downloaded from the device on the network based on the contents of the electronic mail when the data updating is determined to be necessary.

13. The image forming apparatus according to claim 12, wherein the electronic mail sent from the external device includes version information on data to be updated, and said CPU determines whether or not the data updating is necessary by comparing the version information included in the electronic mail with version information on the data stored in the memory.

14. The image forming apparatus according to claim 12, wherein said CPU causes the network interface to notify the external device that data updating based on the electronic mail is unnecessary, when the data updating is determined to be unnecessary.

15. An image forming system comprising: an image forming apparatus which stores data in a memory thereof beforehand; and an external device capable of exchanging electronic mail with the image forming apparatus,
said external device including a modem which sends electronic mail to the image forming apparatus to call for updating of the data stored in the memory of the image forming apparatus, and
said image forming apparatus includes: a network interface through which updating data is downloaded from a device on a network based on contents of the electronic mail in response to the reception of that electronic mail; and a CPU which executes updating processing for the data stored in the memory based on the updating data downloaded by the network interface.

16. The image forming system according to claim 15, wherein the electronic mail sent from the external device includes information indicating data to be updated, and information indicating which device on the network holds the updating data.

17. The image forming system according to claim 15, wherein said CPU writes the updating data once again if the writing of the updating data in the memory fails and a number of times of failure is within a predetermined number, and determines that an error occurs in data updating processing if the number of times of failure reaches said predetermined number.

18. The image forming apparatus according to claim 15, wherein said CPU causes the network interface to notify the external device of a result of the data updating processing.

19. The image forming system according to claim 15, wherein said CPU determines whether or not data updating is necessary based on the contents of the electronic mail when the image forming apparatus has received the electronic mail from the external device, and
said network interface enables the updating data to be downloaded from the device on the network based on the contents of the electronic mail when the data updating is determined to be necessary.

20. The image forming system according to claim 19, wherein the electronic mail sent from the external device includes version information on data to be updated, and said CPU determines whether or not the data updating is necessary by comparing the version information included in the electronic mail with version information on the data stored in the memory.

21. The image forming system according to claim 19, wherein said CPU causes the network interface to notify the external device that data updating based on the electronic mail is unnecessary, when the data updating is determined to be unnecessary.
